(19) United States
(12) Patent Application Publication
(10) Pub. No.: US 2014/0085463 A1
(43) Pub. Date: Mar. 27, 2014

(54) MONITORING CAMERA FOR GENERATING PRIVACY MASK AND METHOD OF CONTROLLING THE SAME

(71) Applicant: SAMSUNG TECHWIN CO., LTD., Changwon-city (KR)

(72) Inventor: Bong-hyen KWON, Changwon-city (KR)

(21) Appl. No.: 13/914,766

(22) Filed: Jun. 11, 2013

(30) Foreign Application Priority Data
Sep. 27, 2012 (KR) 10-2012-0108268

(51) Int. Cl. G06T 11/00

(52) U.S. Cl. CPC G06T 11/00
USPC 348/143

(57) ABSTRACT

One or more embodiments of the exemplary embodiments relate to a monitoring camera for generating a privacy mask and a method of controlling the same. A monitoring camera for generating a polygonal privacy mask includes a polygon obtaining device configured to obtain an area, from a captured image in which a privacy mask is necessary, as a combination of a plurality of polygons; a mask generation device configured to generate at least one privacy mask area using information about the plurality of polygon; and an image processing device configured to process the generated at least one privacy mask area in the captured image.

### CROSS-REFERENCE TO RELATED PATENT APPLICATION

This application claims priority from Korean Patent Application No. 10-2012-0108268, filed on Sep. 27, 2012, in the Korean Intellectual Property Office, the disclosure of which is incorporated herein in its entirety by reference.

### BACKGROUND

1. Field

One or more embodiments of the exemplary embodiments relate to a system and a method of generating a privacy mask. More particularly, one or more embodiments of the exemplary embodiments relate to a method of accurately generating a polygonal privacy mask using a simple process.

2. Description of the Related Art

Recently, monitoring cameras of the related art have been installed inside or outside of buildings, or on the streets, for various purposes. Examples of the various purposes include crime prevention or security. Monitoring cameras of the related art may be connected wirelessly or wired to a main server via a network. A plurality of monitoring cameras of the related art may be simultaneously controlled by the main server.

An image processing apparatus of the related art, such as a monitoring camera or a main server, may capture and store an image. If an accident occurs, a captured image may be viewed on a monitor. Therefore, the accident may be solved using the captured image. However, there are cases when a privacy mask is needed, such that a particular area in a captured image may not be viewed on the monitor. Thus, a monitoring camera may generate a privacy mask on the captured image through image processing.

### SUMMARY

One or more embodiments of the exemplary embodiments may provide a monitoring camera for generating one polygonal privacy mask using a combination of polygonal privacy masks.

According to an aspect of the exemplary embodiments, there is provided a monitoring camera for generating a polygonal privacy mask, the monitoring camera including: a polygon obtaining device configured to obtain an area from a captured image, in which a privacy mask is necessary, as a combination of a plurality of polygons; a mask generation device configured to generate at least one privacy mask area using information about the plurality of polygons; and an image processing device configured to process the generated at least one privacy mask area in the captured image.

When obtaining the area as the combination of polygons, the polygon obtaining device is configured to receive an input of a set of coordinates of four vertices, which form the plurality of polygons.

When all the plurality of polygons overlap with a portion of the captured image in which the privacy mask is necessary, an entire area of the portion of the captured image may be covered.

The mask generation unit may be configured to generate a portion of the captured image, obtained by combining one or more polygons among the plurality of polygons, as the at least one privacy mask area.

The mask generation unit may be configured to generate the at least one privacy mask area, by sequentially overlapping the plurality of polygons with the captured image.

When one scanning line moves through an entire captured image, if the scanning line is placed at a particular location, the mask generation device may be configured to set an area of the scanning line, which corresponds to an inside of the plurality of polygons, as a partial area of a privacy mask, and set a result of combining partial areas of the privacy mask, obtained by moving the scanning line through the entire captured image, as the at least one privacy mask.

With regard to the partial area of the privacy mask, the scanning line may be a line from a point at which the scanning line meets an area which corresponds to at least one of the plurality of polygons to a point at which the scanning line does not meet any of the plurality of polygons.

When the scanning line overlaps with at least one polygon of the plurality of polygons at the particular location, a partial area of the scanning line, which overlaps with the at least one polygon, may be set as the partial area of the privacy mask.

The image processing device may be located inside the monitoring camera, and after the partial area of the privacy mask is processed on the captured image, the partial area of the privacy mask of the captured image may not be changed using an external image processing apparatus.

According to an aspect of the exemplary embodiments, there is provided a method of controlling a monitoring camera for generating a polygonal privacy mask, the method including: obtaining an area in a captured image, in which a privacy mask is necessary, as a combination of a plurality of polygons; generating a mask for generating at least one privacy mask area using information about the plurality of polygons; and processing an image for processing the generated at least one privacy mask area on the captured image.

When obtaining the area as the combination of polygons, the obtaining further includes may be receiving an input of a set of coordinates of four vertices, which form the plurality of polygons.

When the plurality of polygons overlap with a portion of the captured image in which the privacy mask is necessary, an entire portion of the captured image may be covered.

The generating of the mask may create a portion of the captured image, obtained by combining one or more polygons among the plurality of polygons, as the at least one privacy mask area.

The generating of the mask may generate the at least one privacy mask area by sequentially overlapping the plurality of polygons with the captured image.

When one scanning line moves through an entire captured image, if the scanning line is placed at a particular location, the generating of the mask may include setting an area of the scanning line, which corresponds to an inside of the plurality of polygons, as a partial area of a privacy mask, and setting a result of combining partial areas of the privacy mask, obtained by moving the scanning line through the entire captured image, as the at least one privacy mask area.

With regard to the partial areas of the privacy mask, the scanning line may be a line from a point at which the scanning line meets an area which corresponds to at least one of the plurality of polygons to a point at which the scanning line does not meet any of the plurality of polygons.

When the scanning line overlaps with at least one of the plurality of polygons at the particular location, a partial line area of the scanning line, which overlaps with the at least one polygon, may be set as the partial area of the privacy mask.

The processing of the image may be performed inside the monitoring camera, and after the partial area of the privacy mask is processed on the captured image, the partial area of the privacy mask area of the captured image may not be changed using an external image processing apparatus.

According to an aspect of the exemplary embodiments, there is provided a monitoring system including: a monitoring camera configured to process a polygonal privacy mask; a main server configured to receive transmission of a captured image from the monitoring camera; and a network configured to communicate between the monitoring camera and the main server, wherein the monitoring camera is configured to generate at least one privacy mask using a combination of a plurality of polygons.

The plurality of polygons may include at least two rectangles.

### BRIEF DESCRIPTION OF THE DRAWINGS

The above and other features and advantages will become more apparent by describing in detail exemplary embodiments thereof, with reference to the attached drawings in which:

FIG. 1 is a configuration map of a monitoring camera system according to an embodiment;

FIG. 2 is a block diagram illustrating a monitoring camera according to an embodiment;

FIG. 3 is a diagram illustrating a shape of a related art privacy mask;

FIG. 4 is a diagram illustrating an internal configuration of a camera masking unit, according to an embodiment;

FIGS. 5A through 5C are diagrams illustrating a process of obtaining a combination of a plurality of rectangles, according to an embodiment;

FIG. 6 is an example of generating a polygonal privacy mask by scanning a captured image with a scanning line according to another embodiment;

FIG. 7 is a flowchart illustrating a process of generating a privacy mask, according to an embodiment; and

FIG. 8 is a flowchart illustrating a process of generating a privacy mask, according to another embodiment.

### DETAILED DESCRIPTION OF THE EXEMPLARY EMBODIMENTS

In the following detailed description, reference is made to the accompanying drawings that show, by way of illustration, specific embodiments which may be practiced. These embodiments are described in sufficient detail to enable those skilled in the art to practice the exemplary embodiments. It is to be understood that the various embodiments of the exemplary embodiments, although different, are not necessarily mutually exclusive. For example, a particular feature, structure, or characteristic described herein, in connection with one embodiment, may be implemented within other embodiments without departing from the spirit and scope of the exemplary embodiments. In addition, it is to be understood that a location or arrangement of individual elements within each disclosed embodiment may be modified without departing from the spirit and scope of the exemplary embodiments. The following detailed description is, therefore, not to be taken in a limiting sense, and the scope of the exemplary embodiments is defined only by the appended claims, appropriately interpreted, along with the full range of equivalents to which the claims are entitled. In the drawings, like numerals refer to the same or similar functionality throughout the several views.

Hereinafter, the will now be described more fully with reference to the accompanying drawings, in which exemplary embodiments are shown.

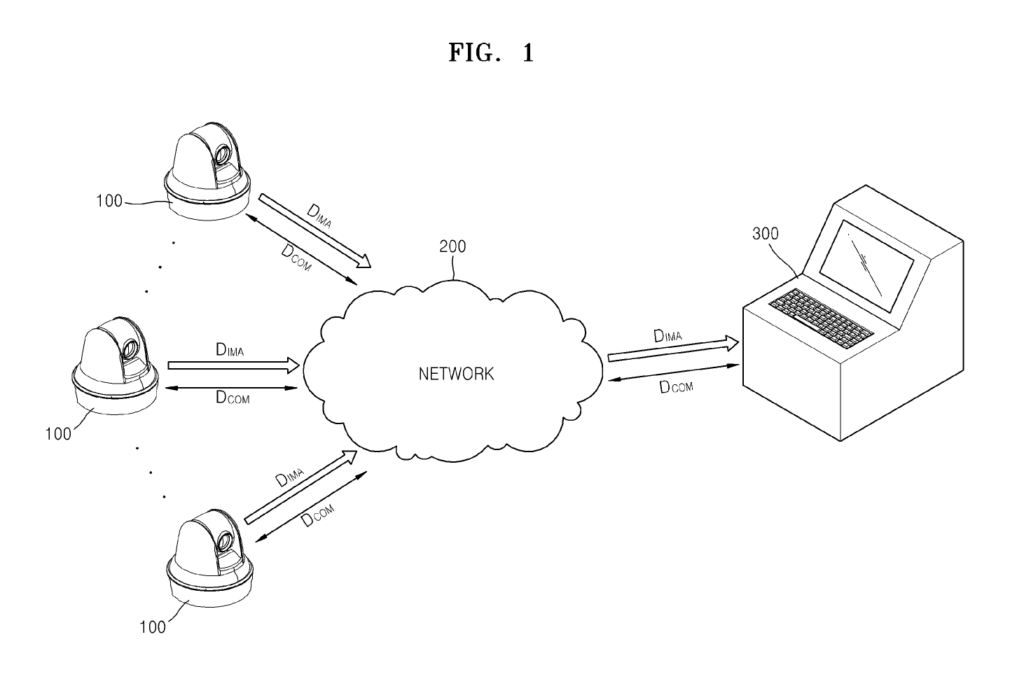

FIG. 1 is a configuration map of a monitoring camera system according to an embodiment.

FIG. 1 is a schematic diagram illustrating a system in which an image processing apparatus is used, according to an embodiment. FIG. 1 shows a system in which at least one monitoring camera 100 communicates with a main server 300 via a network 200. The monitoring camera 100 includes a processing apparatus for generating a polygonal privacy mask, according to an embodiment.

Referring to FIG. 1, a plurality of monitoring cameras 100 exchange data with the main server 300 via the network 200. Specifically, while communicating with the main server 300 via a communication channel DCOM, the monitoring cameras 100 transmit live-view moving image data to the main server 300 via an image data channel DIMA. Of course, only one monitoring camera, instead of a plurality of monitoring cameras, may communicate with a main server. Otherwise, one or more monitoring cameras may communicate with a plurality of main servers. As such, various modifications can be made. A network, which forms the communication channel DCOM and the image data channel DIMA, may various elements that transmit and receive data or a command wirelessly or wired. For example, the network 200 may connect the monitoring camera 100 to the main server 300 via a cable (i.e., wired). Otherwise, the network 200 may connect the monitoring camera 100 to the main server 300 wirelessly using a wireless local area network (LAN).

The main server 300, shown in FIG. 1, has a form similar to that of a computer. However, the main server 300 may be other devices that have a display screen. For example, a personal computer (PC) may be used as the main server 300. The main server 300 may store a live-view moving image received from the monitoring camera 100.

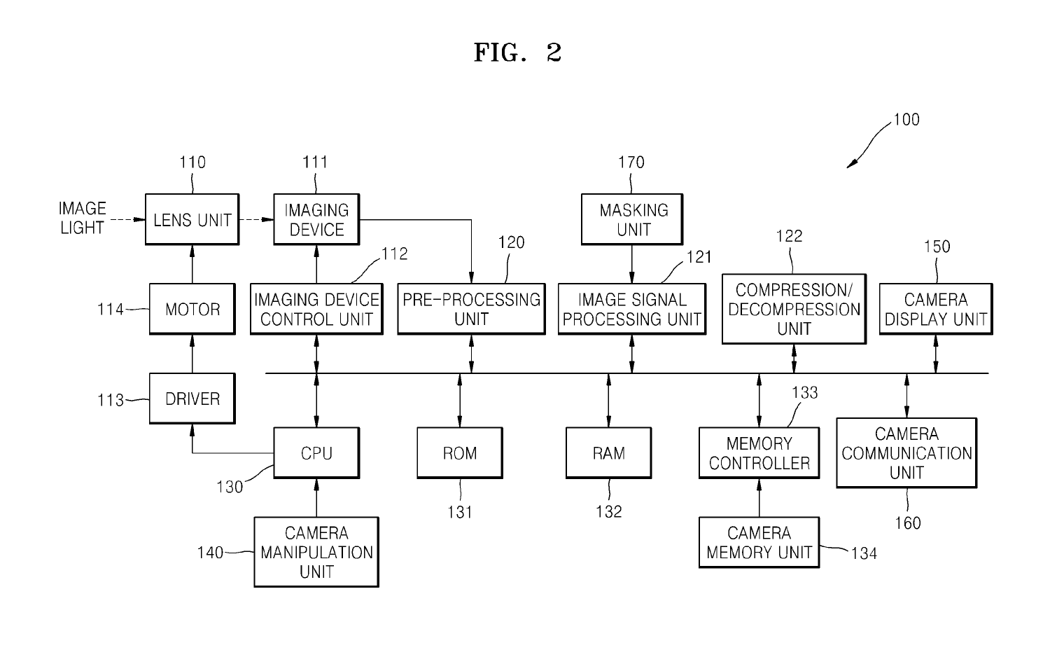

FIG. 2 is a block diagram illustrating the monitoring camera 100 according to an embodiment.

Referring to FIG. 2, the monitoring camera 100, in the current embodiment, may include a lens unit 110, an imaging device 111, an imaging device control unit 112, a driver 113, a motor 114, a pre-processing unit 120, an image signal processing unit 121, a compression/decompression unit 122, a central processing unit (CPU) 130, random only memory (ROM) 131, random access memory (RAM) 132, a memory controller 133, a camera memory unit 134, a camera manipulation unit 140, a camera display unit 150, and a camera communication unit 160.

The lens unit 110 is an optical system which forms an image of optical information, obtained from the outside, on the imaging device 111. The lens unit 110 transmits light, from a subject, to the imaging device 111. The lens unit 110 includes a group of lens, such as a zoom lens for changing a focal length, a focus lens for adjusting a focus, and an iris for adjusting an amount of transmitted light.

When receiving a driving signal from the driver 113, the motor 114 drives the zoom lens, the iris, and the focus lens included in the lens unit 110.

The imaging device 111 is an example of a photoelectric conversion device. The imaging device 111 is formed of a plurality of devices in which photoelectric conversion may be made by capturing image light, which passes through the lens unit 110 and is incident on the imaging device 111, and converting the image light into an electrical signal. Each device generates an electrical signal according to incident light. Thus, an image signal is generated. The imaging device 111 periodically generates an image signal by capturing a frame image for a period, predetermined according to a timing signal received from the imaging device control unit 112. The imaging device 111 may employ a charge-coupled device (CCD) sensor, or a complementary metal oxide semiconductor (CMOS) sensor. The imaging device 111 outputs a digital signal, generated by photoelectric conversion or analog-to-digital conversion, to the pre-processing unit 120.

The imaging device control unit 112 generates a timing signal, and controls the imaging device 111 such that the imaging device 111 captures an image in synchronization with the timing signal.

The pre-processing unit 120 generates an image signal that allows image processing, by processing a digital signal output from the imaging device 111. The pre-processing unit 120 outputs the image signal to the image signal processing unit 121. Additionally, the pre-processing unit 120 controls reading and writing of image data from and to the RAM 132.

The lens unit 110, the imaging device 111, the imaging device control unit 112, and the pre-processing unit 120 may be examples of a photographing unit that photographs a monitored area.

The image signal processing unit 112 receives an image signal from the pre-processing unit 120 and generates an image signal which is image-processed, based on a white balance (WB) control value, a y value, and an edge enhancement control value. The image-processed image signal may be applied to the compression/decompression unit 122. Otherwise, the image-processed image signal may be used for a live-view image, and be transmitted to the camera display unit 150 via the RAM 132.

The masking unit 170, which communicates with the image signal processing unit 121, in the current embodiment, may generate a privacy mask for obscuring display of an area to which monitoring is not necessary, from a monitored area photographed by the monitoring camera 100, according to a manipulation signal received from a user. The generated privacy mask may have a form of a polygon. According to another embodiment of the exemplary embodiments, the masking unit 170 may be included inside the image signal processing unit 121. A function of the masking unit 170 for generating a privacy mask is described below.

The compression/decompression unit 122 receives an image signal, which is not yet compressed. Then, the compression/decompression unit 122 compresses an image signal in the form of compression, such as moving picture experts group (MPEG) standards, Audio Video Interleave (AVI), QuickTime file extension (MOV), or Advanced Streaming Description (ASD). When the monitoring camera 100 includes the camera memory unit 134 in which a captured image may be stored, the compression/decompression unit 112 transmits an image file, which includes image data generated by processing compression, to the memory controller 133, and stores the image file in the camera memory unit 134. Otherwise, the compression/decompression unit 112 may input an image file to the camera communication unit 160, and transmit the image file to the main server 300, which controls the monitoring camera 110, via the camera communication unit 160. Additionally, if the compression/decompression unit 122 includes the camera display unit 150, the compression/decompression unit 122 may extract an image file stored in the camera memory unit 134. Then, the image file is decompressed, such that the image file may be displayed on the camera display unit 150.

The CPU 130 functions as an operation processing device or a control device using a program, and controls processing of each element installed in the monitoring camera 100. The CPU 130, for example, outputs a signal to the driver 113 and drives the motor 114, based on focus control or exposure control. Additionally, the CPU 130 controls each element of the monitoring camera 100, based on a signal transmitted from the camera manipulation unit 140. Additionally, in the current embodiment, only one CPU 130 is included. However, a plurality of CPUs may be employed. For example, a signal-based command and a manipulation-based command may be executed in an additional CPU.

Setting data of a user, related to a photographing condition, may be stored in the ROM 131. Additionally, an algorithm, for controlling the monitoring camera 100 in the CPU, may be stored in the ROM 131. An electrically erasable and programmable read only memory (EEPROM) may be used as the ROM 131.

The RAM 132 is an element in which various types of data, such as an image signal output from the pre-processing unit 120 or data generated in a signal processing process by the image signal processing unit 121, are temporarily stored. A dynamic RAM (DRAM) may be used as the RAM 132.

The memory controller 133 controls writing of image data to the camera memory unit 134 and reading of image data or setting information stored in the camera memory unit 134. The camera memory unit 134 may be, for example, an optical disk, such as a CD, a DVD, or a blue-ray disk, a magneto-optical disk, or a semiconductor memory medium. The camera memory unit 134 stores captured image data. The image data may be image data included in an image file generated by the compression/decompression unit 122. The memory controller 133 and the camera memory unit 134 may be detachably attached to the monitoring camera 100.

However, the memory controller 133 and the camera memory unit 134 are not necessarily installed in the monitoring camera 100. If the monitoring camera 100 is connected to the main server 300 via the network 200, a server memory unit 350 for storing image data in the main server, which controls the monitoring camera 100, may be included. In such a case, image data may be transmitted from the monitoring camera 100 to the main server 300 by the camera communication unit 160, via the network 200.

The camera manipulation unit 140 includes, for example, various buttons or levers installed in the monitoring camera 100. The camera manipulation unit 140 transmits a manipulation signal to the CPU 130, based on manipulation performed by a user. Additionally, the camera manipulation unit 140, in the current embodiment, applies a manipulation signal, for setting an area of a privacy mask according to manipulation made by a user, to a mask setting unit 400. However, the camera manipulation unit 140 is not necessarily installed in the monitoring camera 100. If the monitoring camera 100 is a monitoring camera which is connected via the network 200, a server manipulation unit 330 may be included in the main server 300 which controls the monitoring camera 100. Thus, an operation of the monitoring camera 100 may be controlled using a signal applied by the server manipulation unit 330.

The camera display unit 150 displays a captured image, an image which is captured and stored in the camera memory unit 134, or an image which is decompressed by the compression/decompression unit 122. Additionally, the camera display unit 150 may display various setting screens for controlling the monitoring camera 100. For example, the display unit 150, in the current embodiment, may display a captured image, and a privacy mask which is set on the captured image.

The camera display unit 150 is not necessarily installed in the monitoring camera 100. If the monitoring camera 100 is a monitoring camera which is connected via the network 200, the main server 300, which controls the monitoring camera 100, may include a server display unit 360, so as to display a captured image or various setting screens.

The camera communication unit 160 transmits a captured live-view image which is captured by the monitoring camera 100, or an image which is captured and stored in the camera memory unit 134 to an external apparatus. For example, the external apparatus may be the main server 300 via the wired or the wireless network 200. Additionally, the camera communication unit 160 receives various command signals, which are transmitted from the main server 300, via the network 200.

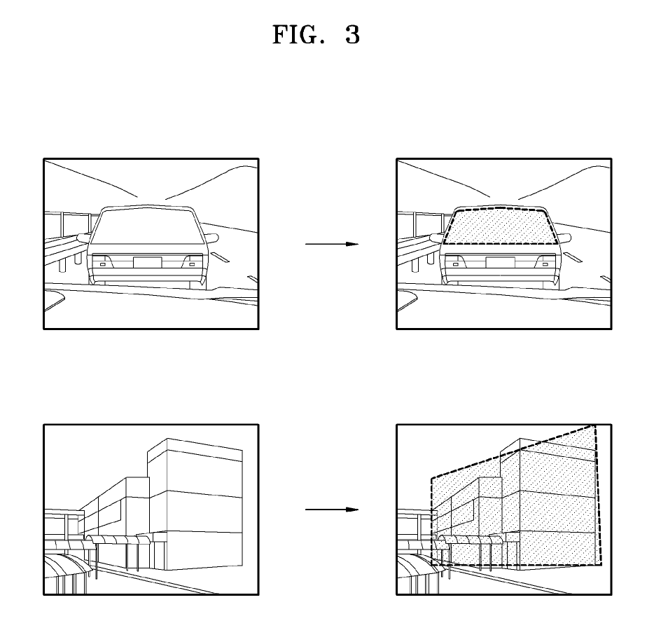

FIG. 3 is a diagram illustrating a shape of a related art privacy mask.

The privacy mask of the related art functions to mask a particular area of a captured image, such that a user may not view the masked area in the captured image. The privacy mask function of the related art is used when a particular area of a person or an object, photographed in an image by using the monitoring camera 100, needs to be protected.

For example, when a closed-circuit television (CCTV), for detecting a speeding vehicle on the road, detects a speeding vehicle and stores an image of the speeding vehicle, a type, color, and a car number of the vehicle are essential elements for identifying a speeding vehicle. However, information about a person in the vehicle is unnecessary, and the privacy of the person may be invaded if the information about the person is disclosed. Accordingly, in such a case, a mask is used to cover a corresponding area of the person in the vehicle, so that the person may not be identified. The function of a privacy mask in the related art is used for such a case.

As shown in FIG. 3, the function of a privacy mask in the related art is implemented by masking a particular area of a screen. In other words, if a passenger inside a car is masked, as shown in the upper illustrations of FIG. 3, the passenger may be masked in the related art using a rectangular-shaped mask which corresponds to a size of a rear windshield of the car. A related art mask employs a rectangular-shaped masking method. A related art method of masking an image in a rectangular shape may be implemented using a simple algorithm. Thus, the rectangular shape is used in the related art.

However, if an area to be privacy-masked is polygon-shaped, as shown in lower illustrations of FIG. 3, a rectangular-shaped mask may not be appropriate. If a building shown in the lower illustrations of FIG. 3 is to be privacy-masked, the related art rectangular-shaped mask may cover an area that does not need to be masked, as well as the building. Therefore, significant information may be lost.

Thus, the implementation of a polygonal privacy mask needs a more complicated algorithm than a rectangle privacy mask. In order to implement a polygonal privacy mask in hardware inside a camera, different hardware, such as an AND circuit, an OR circuit, a flip-flop circuit, and a buffer are needed. Accordingly, in the exemplary embodiments, a polygon-shaped privacy mask is implemented using a combination of rectangles, such that the privacy mask may be appropriately applied to an image.

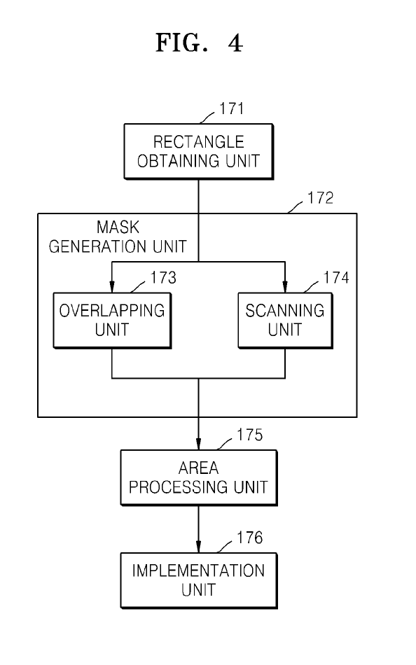

FIG. 4 is a diagram illustrating an internal configuration of a camera masking unit 170, according to an embodiment of the exemplary embodiments.

The camera masking unit 170, according to an embodiment of the exemplary embodiments, functions to generate a polygonal privacy mask. The camera masking unit 170 generates an area of a privacy mask using a combination of a plurality of rectangles, in order to generate a polygonal privacy mask. Then, the camera masking unit 170 processes the generated privacy mask on a captured image.

Referring to FIG. 4, the camera masking unit 170, according to the current embodiment, includes a rectangle obtaining unit 171, a mask generation unit 172, an area processing unit 175, and an implementation unit 176. The mask generation unit 172 includes an overlapping unit 173 and a scanning unit 174.

First, the rectangle obtaining unit 171 receives an input of an area, which needs a privacy mask in a captured image, as a combination of a plurality of rectangles. As described above, even when a polygonal privacy mask is necessary, in order to set a polygonal privacy mask in a shape of a polygon, excess resources in a system may be used. To solve this problem, the monitoring camera 100, according to the current embodiment, obtains information about an area of a mask which is formed of a plurality of rectangles.

The combination of a plurality of rectangles, obtained by the rectangle obtaining unit 171, includes an entire area of a captured image in which a privacy mask is to be set. In other words, an area, in which the privacy mask is to be set, is included in at least one or more rectangles. The combination of a plurality of rectangles may be input directly from a user, or obtained using a result of image processing or a predetermined setting value of a camera.

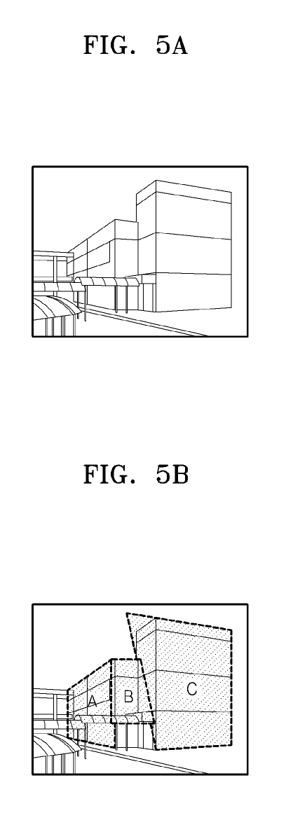

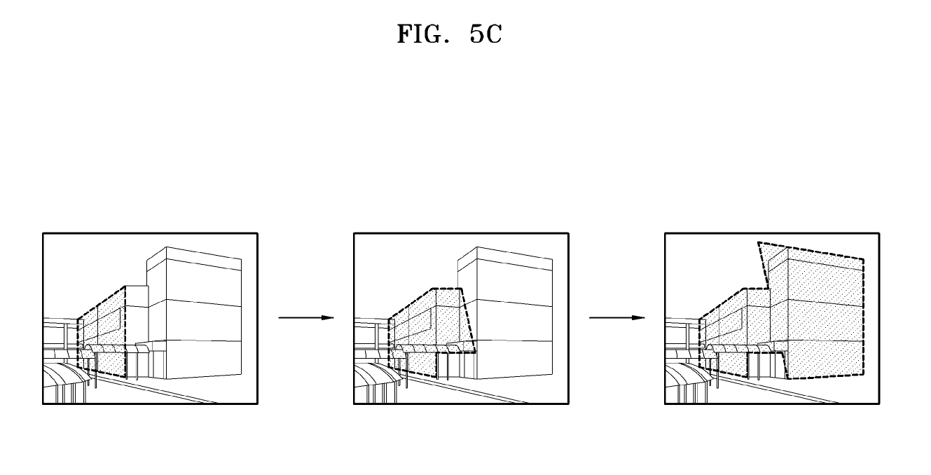

FIGS. 5A through 5C are diagrams illustrating a process of obtaining a combination of a plurality of rectangles, according to an embodiment;

FIG. 5A is a diagram illustrating an example of a captured image in which a privacy mask is to be set. An area of a captured image, in which a privacy mask is to be set, is a building, except for an exit of the building. Thus, a privacy mask in a shape of a polygon is necessary, instead of a rectangle.

FIG. 5B is a result for which the rectangle obtaining unit 171 receives an input of an area, in which a privacy mask is necessary, as a combination of a plurality of rectangles. As described above, the rectangle obtaining unit 171 may receive an input of a plurality of rectangles from a result of image processing by an image processing unit, or an input of a plurality of rectangles directly set by a user. If a user directly sets a plurality of rectangles, the user may set the plurality of rectangles by setting four vertices of a rectangle.

The plurality of rectangles, received by the rectangle obtaining unit 171, covers an entire area of the captured image in which a privacy mask is necessary. In other words, although one rectangle covers only a part of an area in which a privacy mask is necessary, the entire area in which the privacy mask is necessary is covered by at least one rectangle.

The overlapping unit 173 generates one privacy mask area by sequentially overlapping a plurality of rectangles on a capture image.

FIG. 5C is a diagram illustrating a process of generating a privacy mask by sequentially overlapping a plurality of rectangles. Referring to FIG. 5C, the overlapping unit 173 overlaps one of a plurality of rectangles for one process, and eventually generates a privacy mask area. The area, obtained by overlapping one or more of the plurality of rectangles for one process, is processed using an OR operation.

As described in FIG. 5, according to the current embodiment, one polygonal privacy mask may be generated by sequentially overlapping a plurality of rectangles.

According to another embodiment of the exemplary embodiments, the scanning unit 174 sequentially scans a captured image using a scanning line and executes an OR operation on an area which corresponds to a plurality of rectangles, such that one polygonal privacy mask may be generated.

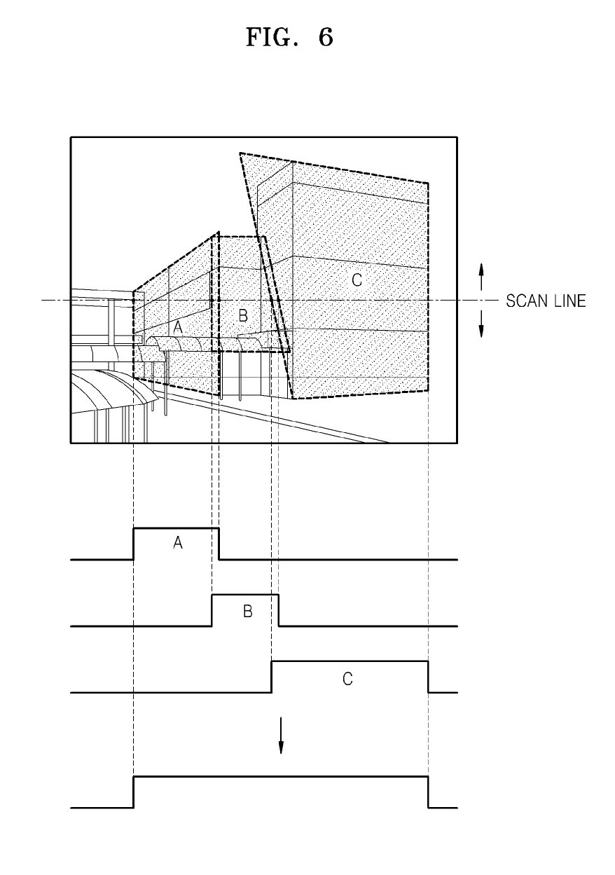

FIG. 6 is an example of generating a polygonal privacy mask by scanning a captured image with a scanning line, according to another embodiment of the exemplary embodiments.

Referring to FIG. 6, similar to FIGS. 5A and 5B, when the rectangle obtaining unit 171 receives an input of information about a plurality of rectangles in a captured image in which a privacy mask is to generated, a polygonal privacy mask is generated using a scanning line.

FIG. 6 illustrates generation of a privacy mask area, in a capture image, by moving a scanning line upwards and downwards. The scanning unit 174 may move a scanning line from up to down, or vice versa. Otherwise, if a scanning line is a vertical line, the scanning unit 174 may move the scanning line from left to right, or vice versa.

As shown in FIG. 6, if a scanning line is placed at a specific location, an area of the scanning line, which overlaps each rectangle, may be obtained. An area setting unit may set an area of a scanning line, which overlaps with each rectangle, as a partial area of a privacy mask.

In other words, the scanning unit 174 generates an area of a scanning line by executing an OR operation on an area which overlaps with a rectangle A, an area which overlaps with a rectangle B, and an area which overlaps with a rectangle C. Then, the scanning unit 174 sets the generated area as a partial area of a privacy mask, at a specific location. In other words, the partial area of the privacy mask is obtained by combining a line from a point in which a scanning line corresponds to at least one of a plurality of rectangles to a point in which the scanning line does not meet any one of the plurality of rectangles.

The scanning unit 174 combines partial areas of a privacy mask, obtained by moving a scanning line through an entire captured image. Thus, the scanning unit 174 sets the combined partial areas as one privacy mask.

According to another embodiment of the exemplary embodiments, a scanning line moves and scans one privacy mask. Thus, a complete privacy mask may be obtained by following only one process, compared to an embodiment of the exemplary embodiments, in which a plurality of rectangles are sequentially overlapped.

The area processing unit 175 processes one privacy mask, which is set by the mask generation unit 172, on a captured image. The masking unit 170, which includes an image processing unit, may be located inside a camera. After the area processing unit 175 processes the privacy mask, which is generated in a captured image, the captured image may not be changed using an external image processing apparatus. The captured image may not be changed using the external image processing apparatus to prevent an external apparatus from changing a masked area or reading information before masking, after a privacy mask is generated.

Then, the implementation unit 176 transmits a captured image, in which a generated privacy mask area is processed, to the image signal processing unit 121, or stores the captured image in the camera memory unit 134. Additionally, the implementation unit 176 may store information about the generated privacy mask in a memory.

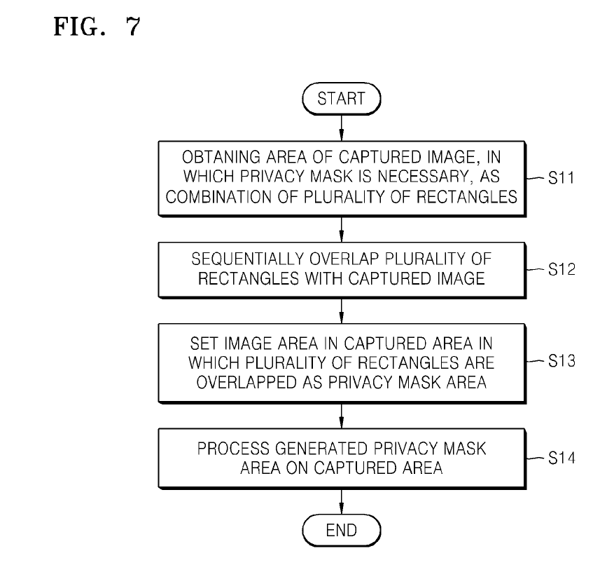

FIG. 7 is a flowchart illustrating a process of generating a privacy mask, according to an embodiment of the exemplary embodiments.

First, in operation S11, an area in which a privacy mask is needed, from among a captured image, is obtained using a plurality of rectangles.

Then, in operation S12, the plurality of rectangles are sequentially overlapped with the captured image.

Then, in operation S13, an image area on the captured image, in which the plurality of rectangles are overlapped, is set as a privacy mask.

Then, in operation S14, a generated privacy mask area is processed on the captured image.

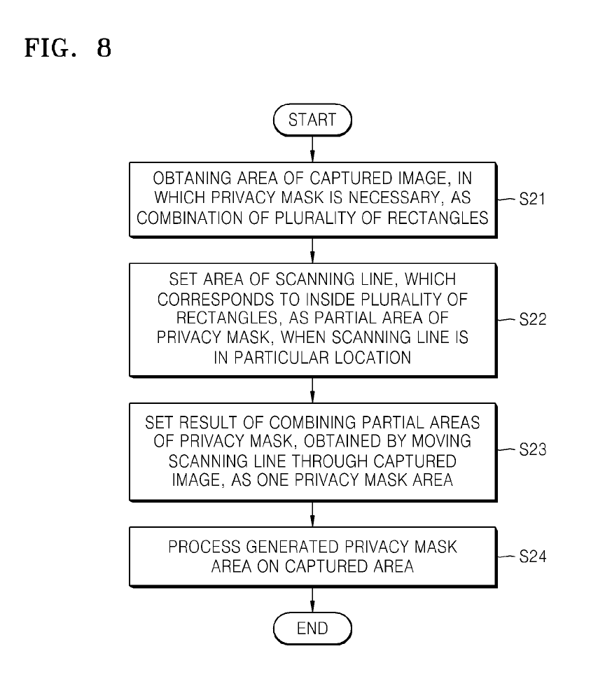

FIG. 8 is a flowchart illustrating a process of generating a privacy mask, according to another embodiment of the exemplary embodiments.

First, in operation S21, an area in which a privacy mask is needed, from among a captured image, is obtained using a plurality of rectangles.

Then, in operation S22, when a scanning line is placed at a particular location, an area of a scanning line, which corresponds to inside the plurality of rectangles, is set as a partial area of a privacy mask.

Then, in operation S23, a result of combining partial areas of the privacy mask, obtained by moving a scanning line through the entire captured image, is set as one privacy mask.

Then, in operation S24, a generated privacy mask area is processed in the captured image.

According to the exemplary embodiments, one polygonal privacy mask may be generated using a combination of rectangle privacy masks, without having a complicated operation.

The particular implementations shown and described herein are illustrative examples of the exemplary embodiments, and are not intended to otherwise limit the scope of the exemplary embodiments in any way. For the sake of brevity, related art electronics, control systems, software development and other functional aspects of the systems (and components of the individual operating components of the systems) may not be described in detail. Furthermore, the connecting lines or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The embodiments of the exemplary embodiments can be implemented in a form of executable program command through a variety of computer means recordable to computer-readable recording media. The computer-readable recording media may include solely or in combination, program commands, data files, and data structures. The program commands recorded to the media may be components specially designed for the exemplary embodiments, or may be usable to a skilled person in a field of computer software. Computer-readable recording media include magnetic media such as a hard disk, a floppy disk, magnetic tape, optical media such as CD-ROM and DVD, magneto-optical media such as a floptical disk, and hardware devices such as ROM, RAM, and flash memory specially designed to store and carry out programs. Program commands include not only a machine language code made by a compiler but also a high level code that can be used by an interpreter etc., and executed by a computer. The hardware devices may be changed into one or more software modules for executing processing according to the exemplary embodiments, or vice versa.

Although the exemplary embodiments are described using a rectangle for a polygon shape, the exemplary embodiments are not limited. The exemplary embodiments may include any polygon shape for generating a privacy mask. As an example, other polygon shapes that may be included in the exemplary embodiments are a triangle, a square, a pentagon, a hexagon, a heptagon, an octagon, a nonagon, or a decagon.

While the exemplary embodiments has been particularly shown and described with reference to exemplary embodiments and drawings thereof, it will be understood by those skilled in the art that various deletions, substitutions, and changes in form and details of the apparatus and method, described above, may be made therein without departing from the spirit and scope of the exemplary embodiments as defined by the appended claims.

Accordingly, the concept of the exemplary embodiments must not be confined to the explained embodiments, and the following patent claims, as well as everything including variations equal or equivalent to the patent claims, pertain to the category of the concept of the exemplary embodiments.

In another exemplary embodiment, any of the rectangle obtaining unit 171, the mask generation unit 172, the area processing unit 175, and the implementation unit 176 in FIG. 4 of the instant specification may include at least one processor, a circuit, or a hardware module for performing their respective functions.

In another exemplary embodiment, any of the lens unit 110, the image device control unit 112, the pre-processing unit 120, the image signal processing unit 122, the compression/decompression unit 122, the camera manipulation unit 140, the camera display unit 150, the camera communication unit 160, and the masking unit in FIG. 2 of the instant specification may include at least one processor, a circuit, or a hardware module for performing their respective functions.

While the exemplary embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A monitoring camera for generating a polygonal privacy mask, the monitoring camera comprising:
a polygon obtaining device configured to obtain an area from a captured image, in which a privacy mask is necessary, as a combination of a plurality of polygons; a mask generation device configured to generate at least one privacy mask area using information about the plurality of polygons; and
an image processing device configured to process the generated at least one privacy mask area in the captured image.

2. The monitoring camera of claim 1, wherein the plurality of polygons comprise at least two rectangles.

3. The monitoring camera of claim 1, wherein, when obtaining the area as the combination of polygons, the polygon obtaining device is configured to receive an input of a set of coordinates of four vertices, which form the plurality of polygons.

4. The monitoring camera of claim 1, wherein, when all the plurality of polygons overlap with a portion of the captured image in which the privacy mask is necessary, an entire area of the portion of the captured image is covered.

5. The monitoring camera of claim 1, wherein the mask generation device is configured to generate a portion of the captured image, obtained by combining one or more polygons among the plurality of polygons, as the at least one privacy mask area.

6. The monitoring camera of claim 1, wherein the mask generation device is configured to generate the at least one privacy mask area by sequentially overlapping the plurality of polygons with the captured image.

7. The monitoring camera of claim 1, wherein, when one scanning line moves through an entire captured image, if the scanning line is placed at a particular location,
the mask generation device is configured to set an area of the scanning line, which corresponds to an inside of the plurality of polygons, as a partial area of a privacy mask, and set a result of combining partial areas of the privacy mask, obtained by moving the scanning line through the entire captured image, as the at least one privacy mask.

8. The monitoring camera of claim 7, wherein, with regard to the partial area of the privacy mask, the scanning line is a line from a point at which the scanning line meets an area which corresponds to at least one of the plurality of polygons to a point at which the scanning line does not meet any of the plurality of polygons.

9. The monitoring camera of claim 7, wherein, when the scanning line overlaps with at least one polygon of the plurality of polygons at the particular location, a partial line of the scanning line, which overlaps with the at least one polygon, is set as the partial area of the privacy mask.

10. The monitoring camera of claim 7, wherein the image processing device is located inside the monitoring camera, and after the partial area of the privacy mask is processed on the captured image, the partial area of the privacy mask of the captured image may not be changed using an external image processing apparatus.

11. A method of controlling a monitoring camera for generating a polygonal privacy mask, the method comprising:
obtaining an area in a captured image, in which a privacy mask is necessary, as a combination of a plurality of polygons;
generating a mask for generating at least one privacy mask area using information about the plurality of polygons; and
processing an image for processing the generated at least one privacy mask area on the captured image.

12. The method of claim 11, wherein, when obtaining the area as the combination of polygons, the obtaining further comprises receiving an input of a set of coordinates of four vertices, which form the plurality of polygons.

13. The method of claim 11, wherein, when the plurality of polygons overlap with a portion of the captured image in which the privacy mask is necessary, an entire portion of the captured image is covered.

14. The method of claim 11, wherein the generating of the mask creates a portion of the captured image, obtained by combining one or more polygons among the plurality of polygons, as the at least one privacy mask area.

15. The method of claim 11, wherein the generating of the mask generates the at least one privacy mask area by sequentially overlapping the plurality of polygons with the captured image.

16. The method of claim 11, wherein, when one scanning line moves through an entire captured image, if the scanning line is placed at a particular location,
the generating of the mask comprises setting an area of the scanning line, which corresponds to an inside of the plurality of polygons, as a partial area of a privacy mask, and
setting a result of combining partial areas of the privacy mask, obtained by moving the scanning line through the entire captured image, as the at least one privacy mask area.

17. The method of claim 16, wherein with regard to the partial areas of the privacy mask, the scanning line is a line from a point at which the scanning line meets an area which corresponds to at least one of the plurality of polygons to a point at which the scanning line does not meet any of the plurality of polygons.

18. The method of claim 16, wherein when the scanning line overlaps with at least one polygon of the plurality of polygons at the particular location, a partial line area of the scanning line, which overlaps with the at least one polygon, is set as the partial area of the privacy mask.

19. The method of claim 11, wherein the processing of the image is performed inside the monitoring camera, and after the partial area of the privacy mask is processed on the captured image, the partial area of the privacy mask of the captured image may not be changed using an external image processing apparatus.

20. A monitoring system comprising:
a monitoring camera configured to process a polygonal privacy mask;
a main server configured to receive transmission of a captured image from the monitoring camera; and
a network configured to communicate between the monitoring camera and the main server,
wherein the monitoring camera is configured to generate at least one privacy mask using a combination of a plurality of polygons.
